(19) United States
(12) Patent Application Publication
(10) Pub. No.: US 2026/0287425 A1
(43) Pub. Date: Sep. 24, 2026

(54) LIGHT DETECTING DEVICE

(71) Applicant: HAMAMATSU PHOTONICS K.K., Hamamatsu-shi, Shizuoka (JP)

(72) Inventors: Hiroki OYAMA, Shizuoka (JP); Katsumi SHIBAYAMA, Shizuoka (JP); Takafumi YOKINO, Shizuoka (JP); Takashi KASAHARA, Shizuoka (JP); Yumi KURAMOTO, Shizuoka (JP)

(21) Appl. No.: 19/476,182

(22) PCT Filed: Mar. 22, 2024
(86) PCT No.: PCT/JP2024/011349

§ 371 Date: Oct. 17, 2025

(30) Foreign Application Priority Data
Apr. 28, 2023 (JP) 2023-074771

(51) Int. Cl. G01J 3/26; G01J 3/02

(52) U.S. Cl. CPC G01J 3/26; G01J 3/0262; G01J 3/0291

(57) ABSTRACT

A light detecting device includes a package having an opening, a light transmission section closing the opening; a Fabry-Perot interference filter disposed inside the package and including a pair of mirror sections having a variable distance from each other in a first direction; a light detector disposed inside the package; a first aperture section having a first aperture located outside the package; and a second aperture section having a second aperture located outside the package. A first surface of the first aperture section facing the second aperture side and surrounding the first aperture has light absorbency. A second surface of the second aperture section facing the first aperture side and surrounding the second aperture is separated from the first surface and has light absorbency.

### TECHNICAL FIELD

The present disclosure relates to a light detecting device including a Fabry-Perot interference filter.

### BACKGROUND ART

There is known a light detecting device including a package having an opening, a light transmission section closing the opening, a Fabry-Perot interference filter disposed inside the package and including a pair of mirror sections, a distance between which being variable, and a light detector disposed inside the package (see, for example, Patent Literature 1). In such a light detecting device, while the distance between the pair of mirror sections is varied in the Fabry-Perot interference filter, light transmitted through the pair of mirror sections among light incident via the light transmission section is detected by the light detector, whereby a spectral spectrum of light to be measured is obtained.

### CITATION LIST

### Patent Literature

Patent Literature 1: Japanese Unexamined Patent Publication No. 2018-141713

### SUMMARY OF INVENTION

### Technical Problem

In the light detecting device as described above, how stray light (for example, light that has not been transmitted through the pair of mirror sections and light that has been obliquely transmitted through the pair of mirror sections) can be suppressed from entering the light detector is extremely important for improving an S/N ratio in wavelength analysis of the light to be measured.

An object of the present disclosure is to provide a light detecting device capable of suppressing stray light from entering a light detector.

### Solution to Problem

A light detecting device according to one aspect of the present disclosure is [1] “a light detecting device including a package having an opening; a light transmission section closing the opening; a Fabry-Perot interference filter disposed on one side of a first direction with respect to the opening and the light transmission section inside the package, and including a pair of mirror sections having a variable distance from each other in the first direction; a light detector disposed on the one side of the first direction with respect to the Fabry-Perot interference filter inside the package; a first aperture section having a first aperture located on the other side of the first direction with respect to the opening and the light transmission section outside the package; and a second aperture section having a second aperture located on the other side of the first direction with respect to the first aperture outside the package, wherein a first surface of the first aperture section facing the second aperture side and surrounding the first aperture has light absorbency, and a second surface of the second aperture section facing the first aperture side and surrounding the second aperture is separated from the first surface, and has light absorbency”.

In the light detecting device according to [1], outside the package, the first aperture is located on the side opposite to the Fabry-Perot interference filter with respect to the opening of the package, and the second aperture is located on the side opposite to the Fabry-Perot interference filter with respect to the first aperture. This makes it difficult for light having a large incident angle to travel from the opening into the package. Furthermore, in the light detecting device according to [1], the first surface of the first aperture section facing the second aperture side and surrounding the first aperture has light absorbency, and the second surface of the second aperture section facing the first aperture side and surrounding the second aperture is separated from the first surface and has light absorbency. As a result, light having a large incident angle is easily attenuated on each of the first surface and the second surface. Therefore, according to the light detecting device according to [1], it is possible to suppress stray light from entering the light detector.

The light detecting device according to one aspect of the present disclosure may be [2] “the light detecting device according to [1], in which an outer edge of the first aperture is located inside an outer edge of the opening when viewed from the first direction”. According to the light detecting device according to [2], it is possible to more reliably suppress stray light from entering the light detector. Furthermore, since the incident angle of the light traveling from the opening into the package becomes small, the S/N ratio and resolution can be improved in wavelength analysis of light to be measured.

The light detecting device according to one aspect of the present disclosure may be [3] “the light detecting device according to [1], in which an outer edge of the second aperture is located inside an outer edge of the opening when viewed from the first direction”. According to the light detecting device according to [3], it is possible to more reliably suppress stray light from entering the light detector. Furthermore, since the incident angle of the light traveling from the opening into the package becomes small, the S/N ratio and resolution can be improved in wavelength analysis of light to be measured.

The light detecting device according to one aspect of the present disclosure may be [4] “the light detecting device according to [1], in which an outer edge of the first aperture is located inside an outer edge of the second aperture when viewed from the first direction, and the outer edge of the second aperture is located inside an outer edge of the opening when viewed from the first direction”. According to the light detecting device according to [4], it is possible to more reliably suppress stray light from entering the light detector. Furthermore, since the incident angle of the light traveling from the opening into the package becomes small, the S/N ratio and resolution can be improved in wavelength analysis of light to be measured.

The light detecting device according to one aspect of the present disclosure may be [5] “the light detecting device according to any one of to [4], in which the first aperture section includes a first surrounding part surrounding the first aperture, and positioning of the first aperture section in the first direction is performed by the first surrounding part and the package”. According to the light detecting device according to [5], at the time of manufacturing the light detecting device, a distance between the opening and the first aperture can be set to a predetermined distance by passive alignment.

The light detecting device according to one aspect of the present disclosure may be [6] “the light detecting device according to [5], in which the second aperture section includes a second surrounding part surrounding the second aperture, and a fitting part connected to the second surrounding part and fitted to the package, positioning of the second aperture section in a second direction perpendicular to the first direction is performed by the fitting part and the package, and positioning of the second aperture section in the first direction is performed by the fitting part and the package or by the second surrounding part and the first surrounding part”. According to the light detecting device according to [6], at the time of manufacturing the light detecting device, a center line of the second aperture can be matched with the center line of the opening by passive alignment, and a distance between the opening and the second aperture and a distance between the first aperture and the second aperture can be set to a predetermined distance by passive alignment.

The light detecting device according to one aspect of the present disclosure may be [7] “the light detecting device according to [6], in which positioning of the first aperture section in the second direction is performed by the first surrounding part and the fitting part”. According to the light detecting device according to [7], at the time of manufacturing the light detecting device, a center line of the first aperture can match with a center line of the second aperture by the passive alignment. Here, since the center line of the second aperture matches with the center line of the opening by the configuration according to [6], as a result, the center line of the first aperture can be caused to match with the center line of the opening by the passive alignment.

The light detecting device according to one aspect of the present disclosure may be [8] “the light detecting device according to any one of to [7], in which the second aperture section is attached to the package such that a distance between the first aperture and the second aperture is adjustable”. According to the light detecting device according to [8], by adjusting the distance between the first aperture and the second aperture, it is possible to balance the light amount and the resolution in the wavelength analysis of light to be measured.

The light detecting device according to one aspect of the present disclosure may be [9] “the light detecting device according to any one of to [8], in which the second surface is an inclined surface approaching the first aperture section as the second surface is away outward from an outer edge of the second aperture”. According to the light detecting device according to [9], since the strength of the portion of the second aperture section surrounding the second aperture is increased, it is possible to suppress distortion generated in the second aperture section at the time of processing and to obtain a highly accurate second aperture section. In addition, when the stray light entering the package is reflected inside the package and comes out to the outside through the opening of the package and the first aperture of the first aperture section, even if a part of the stray light is not absorbed by the second surface which is the inclined surface, the stray light is easily reflected to the outside from the second surface which is the inclined surface, so that it is possible to suppress re-incidence of a part of the stray light into the package.

### Advantageous Effects of Invention

According to the present disclosure, it is possible to provide a light detecting device capable of suppressing stray light from entering a light detector.

### BRIEF DESCRIPTION OF DRAWINGS

FIG. 1 is a cross-sectional view of a light detecting device according to a first embodiment.

FIG. 2 is a perspective view of a Fabry-Perot interference filter illustrated in FIG. 1.

FIG. 3 is a cross-sectional view of the Fabry-Perot interference filter taken along line III-III illustrated in FIG. 2.

FIG. 4 is a plan view of the light detecting device illustrated in FIG. 1.

FIG. 5 is a view for describing an effect of a first aperture section and a second aperture section.

FIG. 6 is a view for describing the effect of the first aperture section and the second aperture section.

FIG. 7 is a view for describing the effect of the first aperture section and the second aperture section.

FIG. 8 is a view for describing the effect of the first aperture section and the second aperture section.

FIG. 9 is a view for describing the effect of the first aperture section and the second aperture section.

FIG. 10 is a view for describing the effect of the first aperture section and the second aperture section.

FIG. 11 is a view for describing the effect of the first aperture section and the second aperture section.

FIG. 12 is a cross-sectional view of a light detecting device according to a modification.

FIG. 13 is a cross-sectional view of the light detecting device according to the modification.

FIG. 14 is a cross-sectional view of the light detecting device according to the modification.

FIG. 15 is a configuration diagram of a light detection system including the light detecting device illustrated in FIG. 1.

FIG. 16 is a view illustrating results of spectroscopic analysis by the light detection system illustrated in FIG. 15.

FIG. 17 is a view illustrating results of the spectroscopic analysis by the light detection system illustrated in FIG. 15.

### DESCRIPTION OF EMBODIMENTS

Hereinafter, an embodiment of the present disclosure will be described in detail with reference to the drawings. Note that, in the drawings, the same or corresponding parts are denoted by the same reference signs, and redundant description will be omitted.

### Configuration of Light Detecting Device

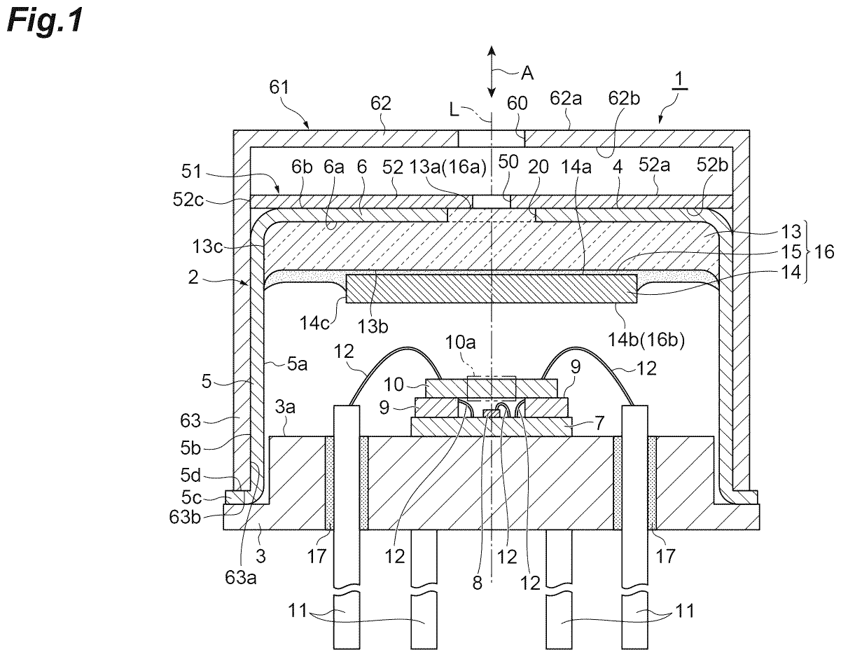

As illustrated in FIG. 1, a light detecting device 1 includes a package 2. The package 2 is a CAN package including a stem 3 and a cap 4. The cap 4 includes a side wall 5 and a top wall 6. The side wall 5 and the top wall 6 are integrally formed of a metal material. The top wall 6 is formed integrally with the side wall 5 so as to cover one opening of the cylindrical side wall 5. The stem 3 is formed of a metal material. The stem 3 is airtightly joined to the side wall 5 so as to cover the other opening of the cylindrical side wall 5.

On an inner surface 3a of the stem 3, a wiring substrate 7 is fixed. The substrate material of the wiring substrate 7 is, for example, silicon, ceramic, quartz, glass, plastic, or the like. On the wiring substrate 7, a light detector 8, and a temperature compensating element (not illustrated) such as a thermistor is mounted. The light detector 8 is, for example, an infrared detector. As the infrared detector, for example, a quantum sensor using InGaAs or the like, a thermal sensor using a thermopile or a bolometer, or the like can be used. In a case where light of different wavelength ranges of ultraviolet, visible, and near infrared regions is detected, a silicon photodiode or other components can be used as the light detector 8, for example. Note that a light receiving region of the light detector 8 may be configured by one light detection element having one light receiving unit, or may be configured by one light detection element having a plurality of light receiving units arranged in an array. Furthermore, the light receiving region of the light detector 8 may include a plurality of light detection elements.

On the wiring substrate 7, a plurality of spacers 9 are fixed. The material of each spacer 9 is, for example, silicon, ceramic, quartz, glass, plastic, or the like. A Fabry-Perot interference filter 10 is fixed on the plurality of spacers 9. That is, the Fabry-Perot interference filter 10 is supported by the plurality of spacers 9. A light transmission region 10a of the Fabry-Perot interference filter 10 faces the light receiving region of the light detector 8. Note that the spacers 9 may be integrally formed with the wiring substrate 7. In addition, the Fabry-Perot interference filter 10 may be supported by one spacer 9.

A plurality of lead pins 11 are fixed to the stem 3. Each of the lead pins 11 penetrates through the stem 3 in a state where electrical insulation and airtightness with the stem 3 are ensured by an insulating member 17. Each of the lead pins 11 is electrically connected to an electrode pad provided to the wiring substrate 7, a terminal of the light detector 8, a terminal of the temperature compensating element, and a terminal of the Fabry-Perot interference filter 10 via wires 12. In the light detecting device 1, input and output of an electric signal to and from each of the light detector 8, the temperature compensating element, and the Fabry-Perot interference filter 10 are performed via the plurality of lead pins 11.

The package 2 has an opening 20. The opening 20 is formed in the top wall 6 of the cap 4 in such a manner as to face the light transmission region 10a of the Fabry-Perot interference filter 10. A light transmitting member 13 is airtightly joined to an inner surface 6a of the top wall 6. The light transmitting member 13 closes the opening 20. The light transmitting member 13 has a light incident surface 13a and a light-emitting surface 13b facing each other, and a side surface 13c. The light incident surface 13a of the light transmitting member 13 is substantially flush with an outer surface 6b of the top wall 6 at the opening 20. The side surface 13c of the light transmitting member 13 is in contact with an inner surface 5a of the side wall 5 of the cap 4. Such a light transmitting member 13 is formed by disposing a glass pellet inside the cap 4 with the opening 20 facing down and melting the glass pellet.

A bandpass filter 14 is fixed to the light-emitting surface 13b of the light transmitting member 13 by a bonding member 15 having light permeability. The bandpass filter 14 includes a light incident surface 14a and a light-emitting surface 14b facing each other, and a side surface 14c. The side surface 14c of the bandpass filter 14 is separated from the inner surface 5a of the side wall 5 of the cap 4. As an example, the bandpass filter 14 includes a light transmitting member formed in a rectangular plate-like shape by a light transmitting material (for example, silicon, glass, or the like) and a dielectric multilayer film (for example, a multilayer film including a combination of a high refractive material such as TiO₂ or Ta₂O₅ and a low refractive material such as SiO₂ or MgF₂) formed on a surface of the light transmitting member on a side opposite to the opening 20. Note that the dielectric multilayer film may be formed on the surface of the light transmitting member on the opening 20 side.

In the present embodiment, the light transmitting member 13, the bonding member 15, and the bandpass filter 14 configure a light transmission section 16. That is, the light transmission section 16 includes the light transmitting member 13 that closes the opening 20 and the bandpass filter 14 disposed on the opposite side of the opening 20 with respect to the light transmitting member 13. The light incident surface 16a of the light transmission section 16 is the light incident surface 13a of the light transmitting member 13, and the light-emitting surface 16b of the light transmission section 16 is the light-emitting surface 14b of the bandpass filter 14. The light-emitting surface 16b of the light transmission section 16 is located inside the package 2.

The light detecting device 1 includes a first aperture section 51 having a first aperture 50 and a second aperture section 61 having a second aperture 60. The first aperture 50 is a light passing hole located on the side opposite to the Fabry-Perot interference filter 10 with respect to the opening 20 outside the package 2. The second aperture 60 is a light passing hole located on the side opposite to the Fabry-Perot interference filter 10 with respect to the first aperture 50 outside the package 2. Details of the first aperture section 51 and the second aperture section 61 will be described later.

In the present embodiment, the second aperture 60 of the second aperture section 61, the first aperture 50 of the first aperture section 51, the opening 20 of the package 2, the light transmission region 10a of the Fabry-Perot interference filter 10, and the light receiving region of the light detector 8 are arranged on the straight line L parallel to a direction (first direction) A in this order. That is, the Fabry-Perot interference filter 10 is disposed on one side of the direction A with respect to the opening 20 and the light transmission section 16 inside the package 2, and the light detector 8 is disposed on one side of the direction A with respect to the Fabry-Perot interference filter 10 inside the package 2. The first aperture 50 is located on the other side of the direction A with respect to the opening 20 and the light transmission section 16 outside the package 2, and the second aperture 60 is located on the other side of the direction A with respect to the first aperture 50 outside the package 2. When viewed from the direction A, the straight line L passes through the centers of the second aperture 60, the first aperture 50, the opening 20, the light transmission region 10a, and the light receiving region of the light detector 8.

In the light detecting device 1 configured as described above, when light to be measured is incident on the light transmission region 10a of the Fabry-Perot interference filter 10 by passing through the second aperture 60, the first aperture 50, the opening 20, and the light transmission section 16 (that is, the light transmitting member 13, the bonding member 15, and the bandpass filter 14), light of a predetermined wavelength among the light to be measured is transmitted through the pair of mirror sections of the Fabry-Perot interference filter 10. The light transmitted through the pair of mirror sections of the Fabry-Perot interference filter 10 enters the light receiving region of the light detector 8 and is detected by the light detector 8. As an example, in order to obtain a spectral spectrum of the light to be measured, in the light detecting device 1, while a voltage applied to the Fabry-Perot interference filter 10 is varied (that is, while the distance between the pair of mirror sections is varied in the Fabry-Perot interference filter 10), the light transmitted through the light transmission region 10a of the Fabry-Perot interference filter 10 is detected by the light detector 8.

### Configuration of Fabry-Perot Interference Filter

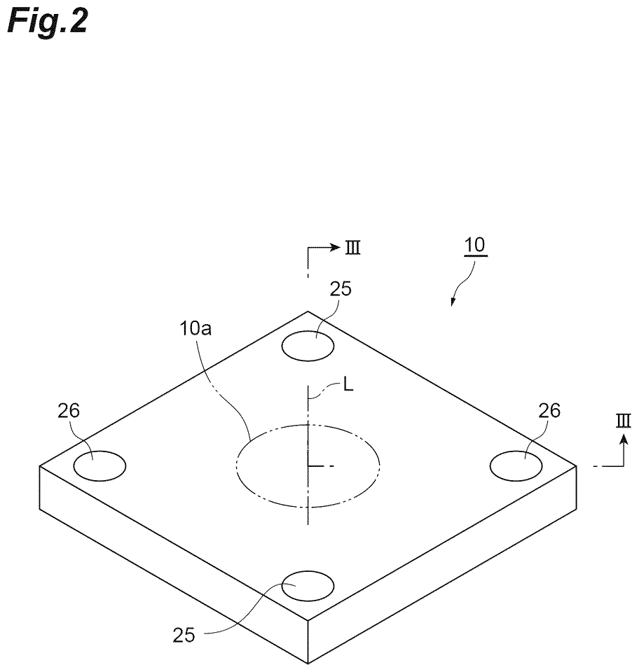

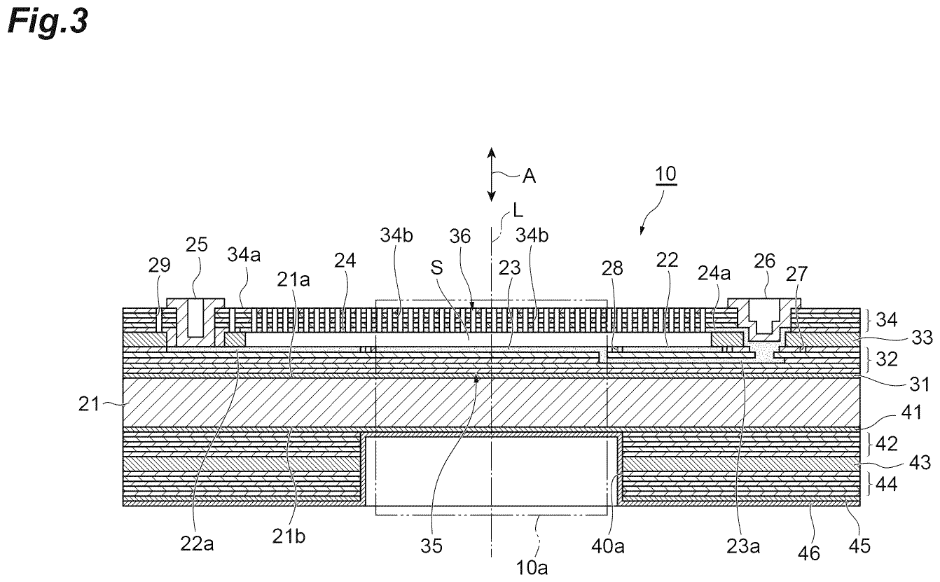

As illustrated in FIG. 2, the Fabry-Perot interference filter 10 includes the light transmission region 10a. As an example, the Fabry-Perot interference filter 10 has a rectangular plate-like shape, and the light transmission region 10a has a columnar shape. As illustrated in FIG. 3, the Fabry-Perot interference filter 10 includes a first mirror section 35 and a second mirror section 36 as the pair of mirror sections. A distance between the first mirror section 35 and the second mirror section 36 is variable in the direction A. The first mirror section 35 and the second mirror section 36 face each other in the direction A.

The Fabry-Perot interference filter 10 includes a substrate 21. On a surface 21a of the substrate 21 on the light incident side, an anti-reflective layer 31, a first laminated body 32, an intermediate layer 33, and a second laminated body 34 are laminated in the order. A gap (air gap) S is formed between the first laminated body 32 and the second laminated body 34 by the intermediate layer 33 of a frame shape. The material of the substrate 21 is, for example, silicon, quartz, glass, or the like. When the material of the substrate 21 is silicon, the material of each of the anti-reflective layer 31 and the intermediate layer 33 is, for example, silicon oxide or the like. A thickness of the intermediate layer 33 is, for example, an integral multiple of ½ of a design center wavelength. Note that the thickness of the intermediate layer 33 may be larger than the integral multiple of ½ of the design center wavelength, as necessary.

A part of the first laminated body 32 corresponding to the light transmission region 10a functions as the first mirror section 35. The first mirror section 35 is supported by the substrate 21 via the anti-reflective layer 31. As an example, the first laminated body 32 includes a plurality of polysilicon layers and a plurality of silicon nitride layers, each layer of which laminated alternately. An optical thickness of each of the layers configuring the first mirror section 35 is, for example, an integral multiple of ¼ of the design center wavelength. Note that a silicon oxide layer may be used instead of the silicon nitride layer.

A part of the second laminated body 34 corresponding to the light transmission region 10a functions as the second mirror section 36 facing the first mirror section 35 via the gap S. The second mirror section 36 is supported by the substrate 21 via the anti-reflective layer 31, the first laminated body 32, and the intermediate layer 33. As an example, the second laminated body 34 includes a plurality of polysilicon layers and a plurality of silicon nitride layers, each layer of which laminated alternately. An optical thickness of each of the layers configuring the second mirror section 36 is, for example, the integral multiple of ¼ of the design center wavelength. Note that a silicon oxide layer may be used instead of the silicon nitride layer.

In a part of the second laminated body 34 corresponding to the gap S, a plurality of through-holes 34b are formed so as to reach the gap S from a surface 34a of the second laminated body 34 on the side opposite to the gap S. The plurality of through-holes 34b are formed to an extent that they do not substantially affect the function of the second mirror section 36. The plurality of through-holes 34b are used when the gap S is formed by removing a part of the intermediate layer 33 by etching.

In the first mirror section 35, a first electrode 22 is formed in such a manner as to surround the light transmission region 10a. In the first mirror section 35, a second electrode 23 is formed in such a manner as to include the light transmission region 10a. Each of the first electrode 22 and the second electrode 23 is formed by doping a part of a polysilicon layer with an impurity to lower the resistance of the part. A size of the second electrode 23 is substantially the same as a size of the light transmission region 10a.

In the second mirror section 36, a third electrode 24 is formed. The third electrode 24 faces the first electrode 22 and the second electrode 23 via the gap S in the direction A. The third electrode 24 is formed by doping a part of a polysilicon layer with an impurity to lower the resistance of the part.

In the Fabry-Perot interference filter 10, the second electrode 23 is located on the same plane as the first electrode 22 in the direction perpendicular to the direction A. The distance between the second electrode 23 and the third electrode 24 is substantially the same as the distance between the first electrode 22 and the third electrode 24. When viewed from the direction A, the second electrode 23 is surrounded by the first electrode 22.

The Fabry-Perot interference filter 10 includes a pair of terminals 25 with the light transmission region 10a interposed therebetween. Each of the terminals 25 is disposed in a through-hole extending from the surface 34a of the second laminated body 34 to the first laminated body 32. Each of the terminals 25 is electrically connected to the first electrode 22 via wiring 22a.

The Fabry-Perot interference filter 10 includes a pair of terminals 26 with the light transmission region 10a interposed therebetween. Each of the terminals 26 is disposed in a through-hole extending from the surface 34a of the second laminated body 34 to the intermediate layer 33. Each of the terminals 26 is electrically connected to the second electrode 23 via wiring 23a and is also electrically connected to the third electrode 24 via wiring 24a. Note that a direction in which the pair of terminals 26 are arranged with the light transmission region 10a interposed therebetween is a direction perpendicular to a direction in which the pair of terminals 25 are arranged with the light transmission region 10a interposed therebetween (see FIG. 2).

A pair of trenches 27 are formed in the first laminated body 32. Each of the trenches 27 annularly extends in such a manner as to surround a part of the wiring 23a extending from each terminal 26 along the direction A. Each of the trenches 27 electrically insulates the first electrode 22 from the wiring 23a. A trench 28 is formed in the first laminated body 32. The trench 28 annularly extends along an inner edge of the first electrode 22. The trench 28 electrically insulates the first electrode 22 from the second electrode 23. Regions inside the trenches 27 and 28 may be filled with an insulating material or void.

A pair of trenches 29 are formed in the second laminated body 34. Each of the trenches 29 annularly extends in such a manner as to surround each of the terminals 25. Each of the trenches 29 electrically insulates each of the terminals 25 from the third electrode 24. Regions inside the trenches 29 may be filled with an insulating material or void.

On a surface 21b of the substrate 21 on the light emitting side, an anti-reflective layer 41, a third laminated body 42, an intermediate layer 43, and a fourth laminated body 44 are laminated in the order. The anti-reflective layer 41 and the intermediate layer 43 have a similar configuration to those of the anti-reflective layer 31 and the intermediate layer 33, respectively. The third laminated body 42 and the fourth laminated body 44 have lamination configurations symmetrical to those of the first laminated body 32 and the second laminated body 34, respectively, with respect to the substrate 21. The anti-reflective layer 41, the third laminated body 42, the intermediate layer 43, and the fourth laminated body 44 have a function of suppressing warping of the substrate 21.

In the third laminated body 42, the intermediate layer 43, and the fourth laminated body 44, an opening 40a is formed in such a manner as to include the light transmission region 10a. When viewed from the direction A, a size of the opening 40a is substantially the same as the size of the light transmission region 10a. The opening 40a is open on the light emitting side, and a bottom surface of the opening 40a reaches the anti-reflective layer 41. A light shielding layer 45 is formed on a surface of the fourth laminated body 44 on the light emitting side. The material of the light shielding layer 45 is, for example, aluminum or the like. A protective layer 46 is formed on a surface of the light shielding layer 45 and an inner surface of the opening 40a. The material of the protective layer 46 is, for example, aluminum oxide or the like. Note that by setting a thickness of the protective layer 46 to 100 nm or less (preferably, about 30 nm), optical influence by the protective layer 46 can be made negligible.

In the Fabry-Perot interference filter 10 configured as described above, when a potential difference is generated between the first electrode 22 and the third electrode 24 by applying a voltage to the first electrode 22 and the third electrode 24 via the plurality of terminals 25 and 26, an electrostatic force corresponding to the potential difference is generated between the first electrode 22 and the third electrode 24. With the electrostatic force generated between the first electrode 22 and the third electrode 24, the second mirror section 36 is attracted to the first mirror section 35, and the distance between the first mirror section 35 and the second mirror section 36 is adjusted. At this point, the second electrode 23 having the same potential as that of the third electrode 24 functions as a compensation electrode, and the second mirror section 36 is kept flat in the light transmission region 10a. As described above, in the Fabry-Perot interference filter 10, the distance between the first mirror section 35 and the second mirror section 36 is allowed to be variable. Here, the wavelength of light transmitted through the Fabry-Perot interference filter 10 depends on the distance between the first mirror section 35 and the second mirror section 36. Therefore, the wavelength of the light transmitted through the Fabry-Perot interference filter 10 can be selected by adjusting the voltage (potential difference generated between the first electrode 22 and the third electrode 24) applied to the first electrode 22 and the third electrode 24.

### Configurations of First Aperture Section and Second Aperture Section

As illustrated in FIG. 1, the first aperture section 51 is configured by a plate-like first surrounding part 52. The first surrounding part 52 continuously surrounds the first aperture 50 when viewed from the direction A. That is, the first aperture section 51 in the present embodiment is an annular member provided separately from the package 2. The first aperture section 51 is disposed on the outer surface 6b of the top wall 6. The first surrounding part 52 has a pair of surfaces 52a and 52b facing each other and a side surface 52c. The surface (first surface) 52a is a surface facing the second aperture 60 side, and the surface 52b is a surface facing the side opposite to the second aperture 60. When viewed from the direction A, the surface 52a continuously surrounds the first aperture 50. The surface 52b is in contact with the outer surface 6b of the top wall 6. That is, the first aperture 50 is continuous with the opening 20. In the present embodiment, each of the surfaces 52a and 52b is a plane perpendicular to the direction A.

At least the surface 52a of the outer surface of the first aperture section 51 has light absorbency. As an example, chromium plating, black alumite treatment, electroless nickel plating, application of black paint, and the like are applied to at least the surface 52a of the first aperture section 51 formed using aluminum, stainless steel, or the like (in addition, a roughening treatment may be performed), so that light absorbency with respect to light in a visible to near-infrared wavelength range is imparted to at least the surface 52a. In the present embodiment, the light absorbency is imparted to the entire outer surface of the first aperture section 51. Thus, the light absorbency is also imparted to the entire surface 52a. Note that in the surface having light absorbency, reflectance of incident light is suppressed to, for example, 20% or less. The reflectance is preferably 10% or less, and more preferably 5% or less. In a case where the reflectance has wavelength dependency or incident angle dependency, the reflectance may be within this numerical value as a rough tendency in the wavelength band used by the Fabry-Perot interference filter 10. For example, the reflectance may be measured at a representative incident angle (for example, 5°, 30°, 45°, and 60°), and an average value thereof may be included in the numerical value.

The second aperture section 61 is configured by a plate-like second surrounding part 62 and a cylindrical fitting part 63. The second surrounding part 62 continuously surrounds the second aperture 60 when viewed from the direction A. The fitting part 63 is connected to the second surrounding part 62 and fits to the package 2. In the present embodiment, the fitting part 63 has a cylindrical shape and is fitted to the side wall 5 of the cap 4. The second surrounding part 62 is formed integrally with the fitting part 63 so as to cover the opening of the cylindrical fitting part 63 on the side opposite to the stem 3. The second surrounding part 62 has a pair of surfaces 62a and 62b facing each other. The surface 62a is a surface facing the side opposite to the first aperture 50, and the surface (second surface) 62b is a surface facing the first aperture 50 side. The surface 62b continuously surrounds the second aperture 60 when viewed from the direction A, and is separated from the surface 52a of the first aperture section 51 via a gap. That is, the second aperture 60 is separated from the first aperture 50. In the present embodiment, each of the surfaces 62a and 62b is a plane perpendicular to the direction A. In the present embodiment, the surface 52a of the first aperture section 51 and the surface 62b of the second aperture section 61 are substantially parallel to each other.

The distance between the surface 52a of the first aperture section 51 and the surface 62b of the second aperture section 61 is preferably smaller than the width of the first surrounding part 52 (the distance from the outer edge of the first aperture 50 to the outer edge of the first aperture section 51) when viewed from the direction A and smaller than the width of the second surrounding part 62 (the distance from the outer edge of the second aperture 60 to the outer edge of the second aperture section 61) when viewed from the direction A. In this case, as described later, stray light entering between the surface 52a and the surface 62a is suitably attenuated by being repeatedly reflected between both surfaces.

At least the surface 62b of the outer surface of the second aperture section 61 has light absorbency. As an example, chromium plating, black alumite treatment, electroless nickel plating, application of black paint, and the like are applied to at least the surface 62b of the second aperture section 61 formed using aluminum, stainless steel, or the like (in addition, a roughening treatment may be performed), so that light absorbency with respect to light in a visible to near-infrared wavelength range is imparted to at least the surface 62b. In the present embodiment, the light absorbency is imparted to the entire surface 62b.

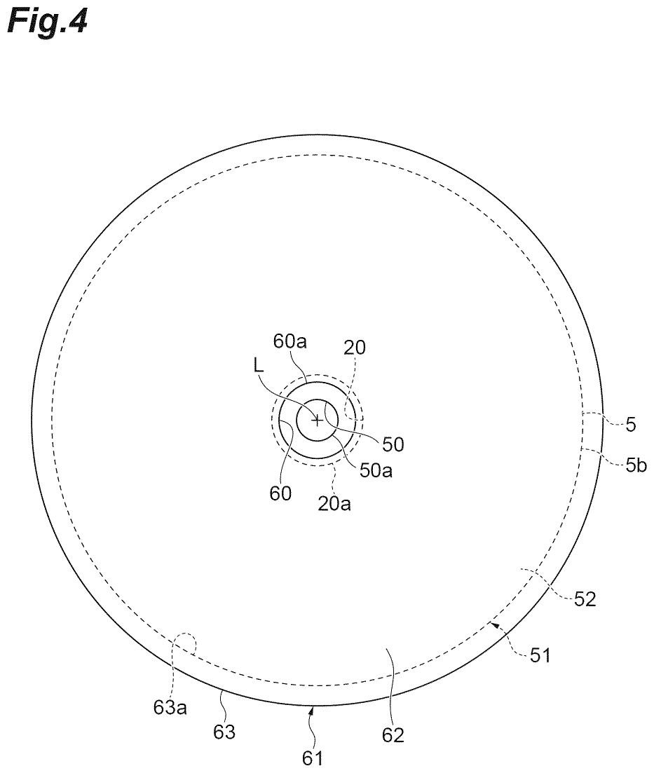

As illustrated in FIG. 4, when viewed from the direction A, each of the outer edge 50a of the first aperture 50 and the outer edge 60a of the second aperture 60 is located inside the outer edge 20a of the opening 20. When viewed from the direction A, an outer edge 50a of the first aperture 50 is located inside the outer edge 60a of the second aperture 60. In the present embodiment, the shape of each of the opening 20, the first aperture 50, and the second aperture 60 when viewed from the direction A is a circular shape centered on the position of the straight line L.

As illustrated in FIG. 1, the positioning of the second aperture section 61 in the direction (second direction) perpendicular to the direction A is performed by the fitting part 63 and the package 2. Specifically, the positioning of the second aperture section 61 in the direction perpendicular to the direction A is performed by fitting the inner surface 63a of the fitting part 63 and the outer surface 5b of the side wall 5 of the cap 4. The positioning of the second aperture section 61 in the direction A is performed by the fitting part 63 and the package 2. Specifically, the positioning of the second aperture section 61 in the direction A is performed by contact between the end surface 63b of the fitting part 63 and the surface 5d of the flange 5c of the side wall 5. The end surface 63b is an end surface of the cylindrical fitting part 63 on the side opposite to the second surrounding part 62. The flange 5c is an outward flange provided at an end portion of the cylindrical side wall 5 on a side opposite to the top wall 6, and the surface 5d is an end surface of the flange 5c on the top wall 6 side. In a state where the second aperture section 61 is positioned, the second aperture section 61 is fixed to the package 2 by, for example, a bonding member (not illustrated). Note that the fitting part 63 may be configured by a plurality of column portions extending in the direction A.

Positioning of the first aperture section 51 in the direction perpendicular to the direction A is performed by the first surrounding part 52 and the fitting part 63. Specifically, the positioning of the first aperture section 51 in the direction perpendicular to the direction A is performed by fitting the side surface 52c of the first surrounding part 52 and the inner surface 63a of the fitting part 63. The positioning of the first aperture section 51 in the direction A is performed by the first surrounding part 52 and the package 2. Specifically, the positioning of the first aperture section 51 in the direction A is performed by contact between the surface 52b of the first surrounding part 52 and the outer surface 6b of the top wall 6 of the cap 4. In a state where the first aperture section 51 is positioned, the first aperture section 51 is fixed to the package 2 by, for example, a bonding member (not illustrated).

An example of dimensions related to the first aperture section 51 and the second aperture section 61 is as follows. The diameter of the opening 20 is about 1.5 mm, and the width of the opening 20 in the direction A is about 0.4 mm. The diameter of the first aperture 50 is about 650 μm, and the width of the first aperture 50 in the direction A is about 8.2 mm. The diameter of the second aperture 60 is about 750 μm, and the width of the second aperture 60 in the direction A is about 9 mm. The distance between the opening 20 and the first aperture 50 is about 0.1 mm, and the distance between the first aperture 50 and the second aperture 60 is about 2 mm.

### Operations and Effects

In the light detecting device 1, outside the package 2, the first aperture 50 is located on the side opposite to the Fabry-Perot interference filter 10 with respect to the opening 20 of the package 2, and the second aperture 60 is located on the side opposite to the Fabry-Perot interference filter 10 with respect to the first aperture 50. This makes it difficult for light having a large incident angle to travel from the opening 20 into the package 2. Furthermore, in the light detecting device 1, the surface 52a of the first aperture section 51 facing the second aperture 60 side and surrounding the first aperture 50 has light absorbency, and the surface 62b of the second aperture section 61 facing the first aperture 50 side and surrounding the second aperture 60 is separated from the surface 52a and has light absorbency. As a result, light having a large incident angle is easily attenuated on each of the surfaces 52a and 62b. Therefore, according to the light detecting device 1, it is possible to suppress stray light from entering the light detector 8.

In the light detecting device 1, when viewed from the direction A, the outer edge 50a of the first aperture 50 is located inside the outer edge 60a of the second aperture 60, and the outer edge 60a of the second aperture 60 is located inside the outer edge 20a of the opening 20. This makes it possible to more reliably prevent stray light from entering the light detector 8. Furthermore, since the incident angle of the light traveling from the opening 20 into the package 2 becomes small, the S/N ratio and resolution can be improved in wavelength analysis of light to be measured.

In the light detecting device 1, the positioning of the first aperture section 51 in the direction perpendicular to the direction A is performed by the first surrounding part 52 and the fitting part 63, and the positioning of the first aperture section 51 in the direction A is performed by the first surrounding part 52 and the package 2. As a result, at the time of manufacturing the light detecting device 1, the center line of the first aperture 50 can match with the center line of the second aperture 60 by passive alignment, and the distance between the opening 20 and the first aperture 50 can be set to a predetermined distance by passive alignment. The opening 20 of the package 2, the light transmission region 10a of the Fabry-Perot interference filter 10, and the light receiving region of the light detector 8 are positioned to each other such that the straight line L passes through the center thereof when viewed from the direction A. Therefore, when the center line of the second aperture 60 matches with the center line of the opening 20 as described later at the time of manufacturing the light detecting device 1, the center line of the first aperture 50 can also match with the center line of each of the light transmission region 10a of the Fabry-Perot interference filter 10 and the light receiving region of the light detector 8 by passive alignment.

In the light detecting device 1, the positioning of the second aperture section 61 in the direction perpendicular to the direction A is performed by the fitting part 63 and the package 2, and the positioning of the second aperture section 61 in the direction A is performed by the fitting part 63 and the package 2. As a result, at the time of manufacturing the light detecting device 1, a center line of the second aperture 60 can match with the center line of the opening 20 by passive alignment, and a distance between the opening 20 and the second aperture 60 and a distance between the first aperture 50 and the second aperture 60 can be set to a predetermined distance by passive alignment. The opening 20 of the package 2, the light transmission region 10a of the Fabry-Perot interference filter 10, and the light receiving region of the light detector 8 are positioned to each other such that the straight line L passes through the center thereof when viewed from the direction A. Therefore, at the time of manufacturing the light detecting device 1, the center line of the second aperture 60 can match with the center line of each of the light transmission region 10a of the Fabry-Perot interference filter 10 and the light receiving region of the light detector 8 by passive alignment.

### Effects of First Aperture Section and Second Aperture Section

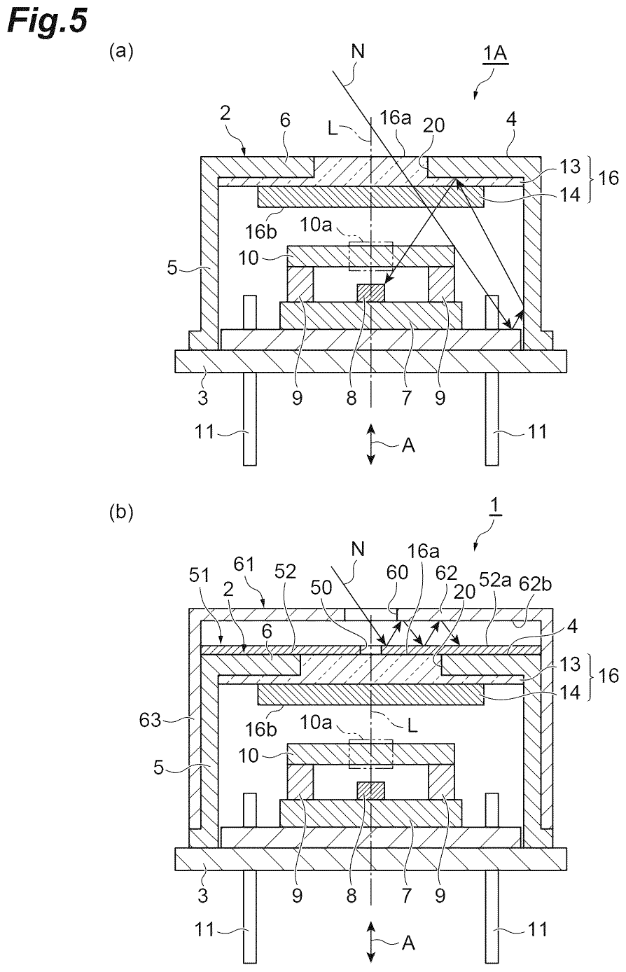

Effects of the first aperture section 51 and the second aperture section 61 will be described in more detail with reference to FIGS. 5 to 11. Note that in FIGS. 5 to 11, illustration of the bonding member 15 and the wire 12 is omitted.

As illustrated in (a) of FIG. 5, in a light detecting device 1A that does not include the first aperture section 51 and the second aperture section 61, light N having a large incident angle travels from the opening 20 into the package 2 and is reflected by the inner surface of the package 2, and enters the light detector 8 without transmitting the light transmission region 10a of the Fabry-Perot interference filter 10 or obliquely transmitting the light transmission region 10a of the Fabry-Perot interference filter 10. On the other hand, as illustrated in (b) of FIG. 5, in the light detecting device 1 including the first aperture section 51 and the second aperture section 61, the light N having a large incident angle does not pass through the first aperture 50 even if passing through the second aperture 60, and is attenuated while being reflected by the surfaces 52a and 62b. Therefore, according to the light detecting device 1 including the first aperture section 51 and the second aperture section 61, it is possible to suppress the incidence of the stray light on the light detector 8 as compared with the light detecting device 1A not including the first aperture section 51 and the second aperture section 61. Note that the light N is light that becomes stray light.

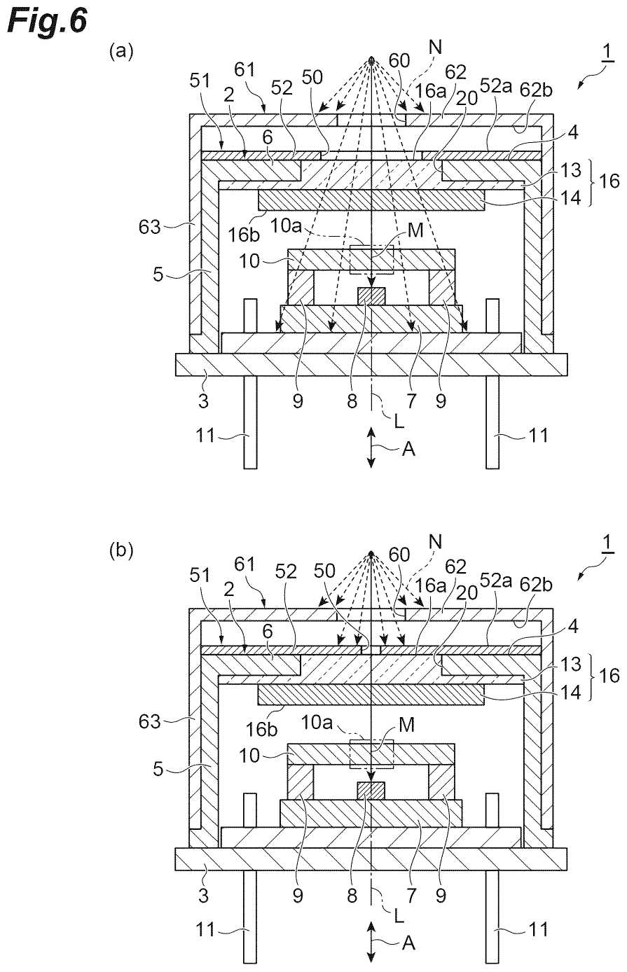

The diameter of the first aperture 50 in the light detecting device 1 illustrated in (a) of FIG. 6 is larger than the diameter of the first aperture 50 in the light detecting device 1 illustrated in (b) of FIG. 6. In this case, in the light detecting device 1 illustrated in (a) of FIG. 6, the light N traveling into the package 2 through the second aperture 60, the first aperture 50, and the opening 20 includes light having a large incident angle. On the other hand, in the light detecting device 1 illustrated in (b) of FIG. 6, the light N traveling into the package 2 through the second aperture 60, the first aperture 50, and the opening 20 does not include light having a large incident angle. Therefore, according to the light detecting device 1 in which the diameter of the first aperture 50 is small, the S/N ratio can be improved in the wavelength analysis of the light to be measured as compared with the light detecting device 1 in which the diameter of the first aperture 50 is large. With the proviso that, even with the light detecting device 1 having the large diameter of the first aperture 50, the S/N ratio can be improved in the wavelength analysis of the light to be measured as compared with the light detecting device 1A not including the first aperture section 51 and the second aperture section 61. Note that the light M is light to be measured.

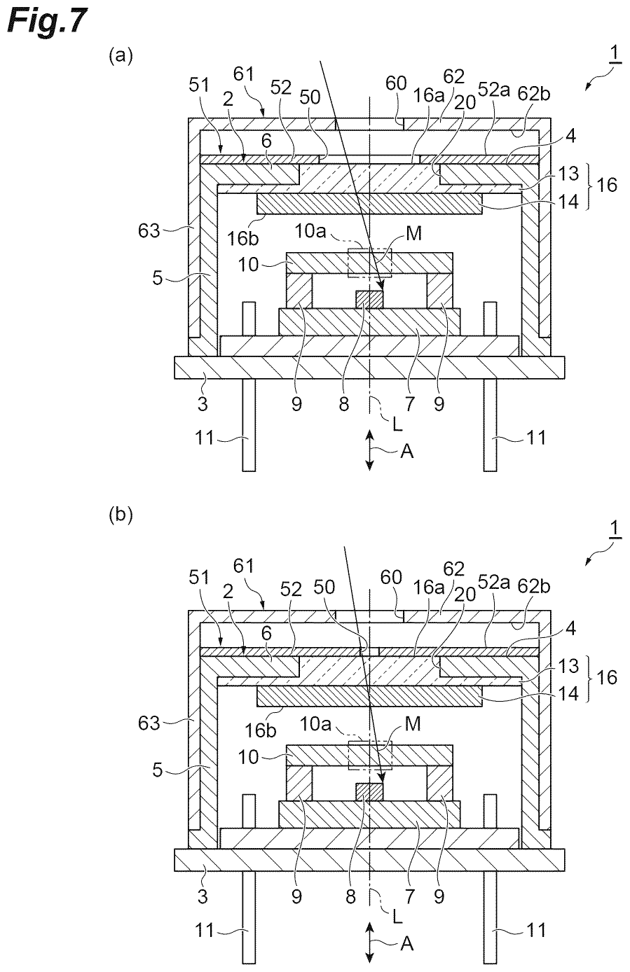

The diameter of the first aperture 50 in the light detecting device 1 illustrated in (a) of FIG. 7 is larger than the diameter of the first aperture 50 in the light detecting device 1 illustrated in (b) of FIG. 7. In this case, in the light detecting device 1 as illustrated in (a) of FIG. 7, the incident angle of the light M that passes through the second aperture 60, the first aperture 50, and the opening 20, and enters the light transmission region 10a of the Fabry-Perot interference filter 10 becomes large. On the other hand, in the light detecting device 1 as illustrated in (b) of FIG. 7, the incident angle of the light M that passes through the second aperture 60, the first aperture 50, and the opening 20, and enters the light transmission region 10a of the Fabry-Perot interference filter 10 becomes small. Therefore, according to the light detecting device 1 in which the diameter of the first aperture 50 is small, the resolution can be improved in the wavelength analysis of the light to be measured as compared with the light detecting device 1 in which the diameter of the first aperture 50 is large. With the proviso that, even with the light detecting device 1 having the large diameter of the first aperture 50, the resolution can be improved in the wavelength analysis of the light to be measured as compared with the light detecting device 1A not including the first aperture section 51 and the second aperture section 61.

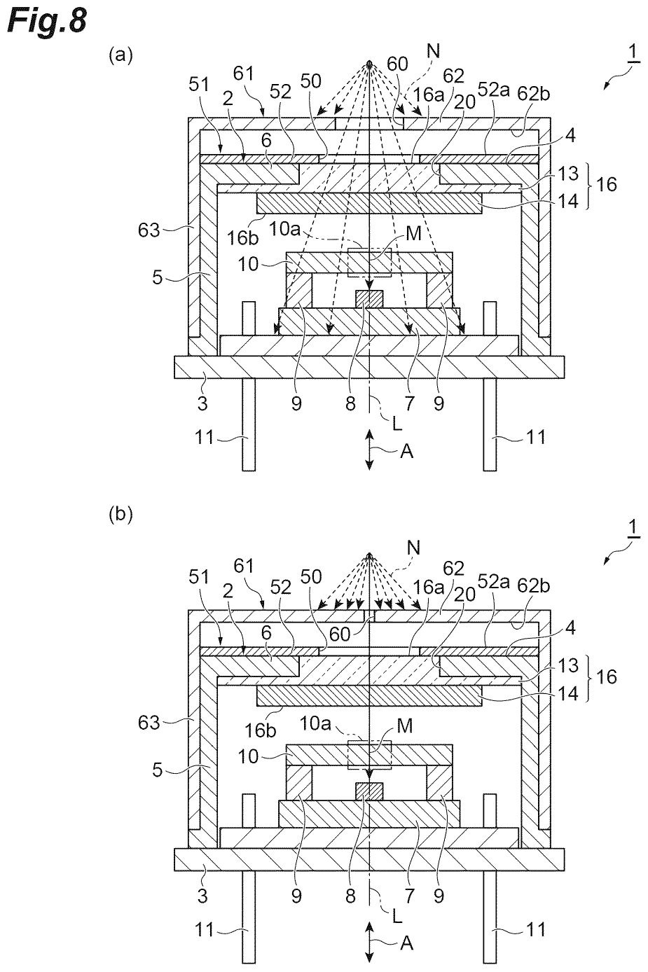

The diameter of the second aperture 60 in the light detecting device 1 illustrated in (a) of FIG. 8 is larger than the diameter of the second aperture 60 in the light detecting device 1 illustrated in (b) of FIG. 8. In this case, in the light detecting device 1 illustrated in (a) of FIG. 8, the light N traveling into the package 2 through the second aperture 60, the first aperture 50, and the opening 20 includes light having a large incident angle. On the other hand, in the light detecting device 1 illustrated in (b) of FIG. 8, the light N traveling into the package 2 through the second aperture 60, the first aperture 50, and the opening 20 does not include light having a large incident angle. Therefore, according to the light detecting device 1 in which the diameter of the second aperture 60 is small, the S/N ratio can be improved in the wavelength analysis of the light to be measured as compared with the light detecting device 1 in which the diameter of the second aperture 60 is large. With the proviso that, even with the light detecting device 1 having the large diameter of the second aperture 60, the S/N ratio can be improved in the wavelength analysis of the light to be measured as compared with the light detecting device 1A not including the first aperture section 51 and the second aperture section 61.

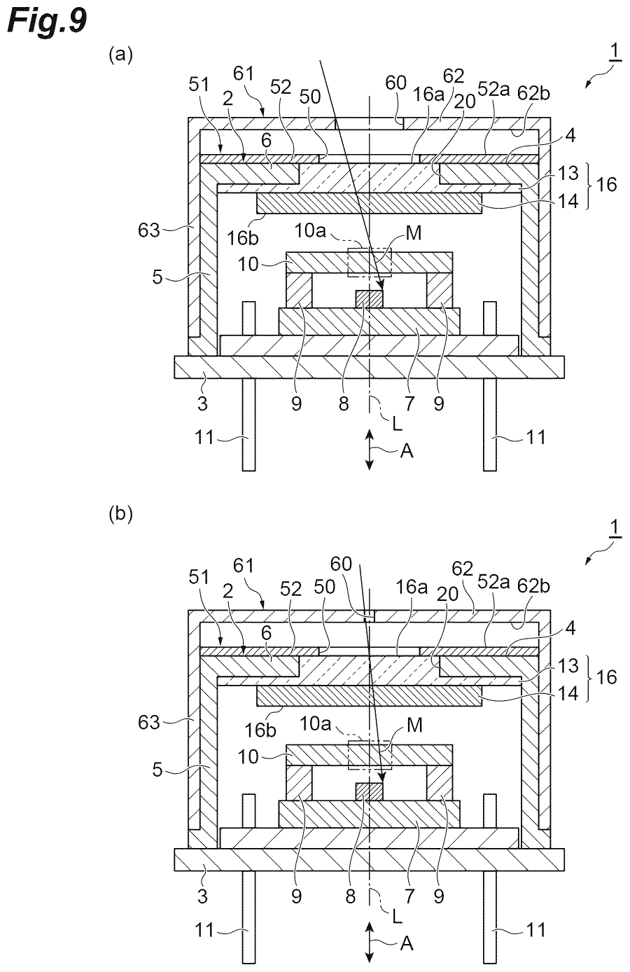

The diameter of the second aperture 60 in the light detecting device 1 illustrated in (a) of FIG. 9 is larger than the diameter of the second aperture 60 in the light detecting device 1 illustrated in (b) of FIG. 9. In this case, in the light detecting device 1 as illustrated in (a) of FIG. 9, the incident angle of the light M that passes through the second aperture 60, the first aperture 50, and the opening 20, and enters the light transmission region 10a of the Fabry-Perot interference filter 10 becomes large. On the other hand, in the light detecting device 1 as illustrated in (b) of FIG. 9, the incident angle of the light M that passes through the second aperture 60, the first aperture 50, and the opening 20, and enters the light transmission region 10a of the Fabry-Perot interference filter 10 becomes small. Therefore, according to the light detecting device 1 in which the diameter of the second aperture 60 is small, the resolution can be improved in the wavelength analysis of the light to be measured as compared with the light detecting device 1 in which the diameter of the second aperture 60 is large. With the proviso that, even with the light detecting device 1 having the large diameter of the second aperture 60, the resolution can be improved in the wavelength analysis of the light to be measured as compared with the light detecting device 1A not including the first aperture section 51 and the second aperture section 61.

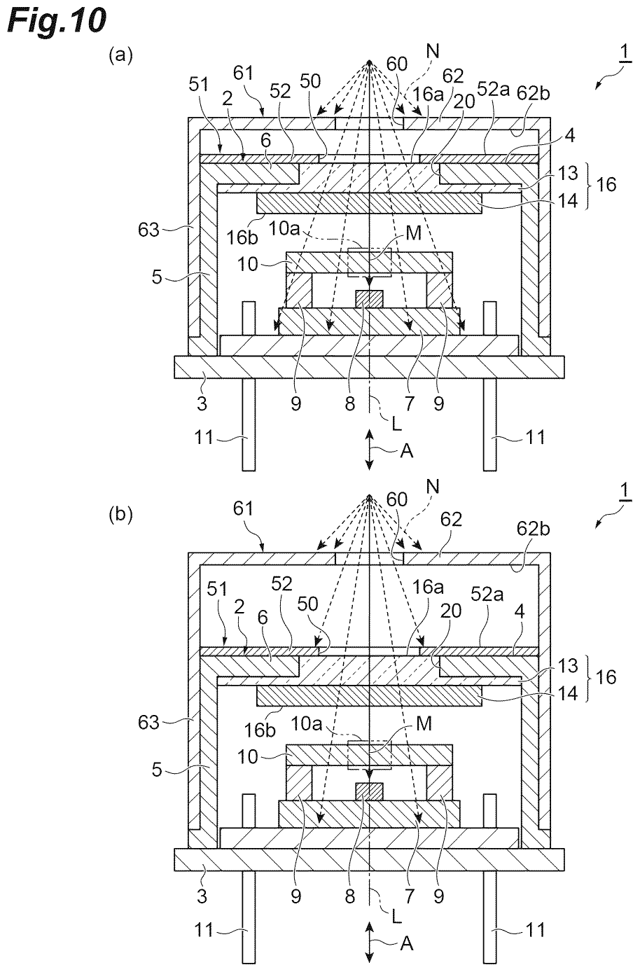

The distance between the first aperture 50 and the second aperture 60 in the light detecting device 1 illustrated in (a) of FIG. 10 is smaller than the distance between the first aperture 50 and the second aperture 60 in the light detecting device 1 illustrated in (b) of FIG. 10. In this case, in the light detecting device 1 illustrated in (a) of FIG. 10, the light N traveling into the package 2 through the second aperture 60, the first aperture 50, and the opening 20 includes light having a large incident angle. On the other hand, in the light detecting device 1 illustrated in (b) of FIG. 10, the light N traveling into the package 2 through the second aperture 60, the first aperture 50, and the opening 20 does not include light having a large incident angle. Therefore, according to the light detecting device 1 in which the distance between the first aperture 50 and the second aperture 60 is large, the S/N ratio can be improved in the wavelength analysis of the light to be measured as compared with the light detecting device 1 in which the distance between the first aperture 50 and the second aperture 60 is small. With the proviso that, even with the light detecting device 1 in which the distance between the first aperture 50 and the second aperture 60 is small, the S/N ratio can be improved in the wavelength analysis of the light to be measured as compared with the light detecting device 1A not including the first aperture section 51 and the second aperture section 61.

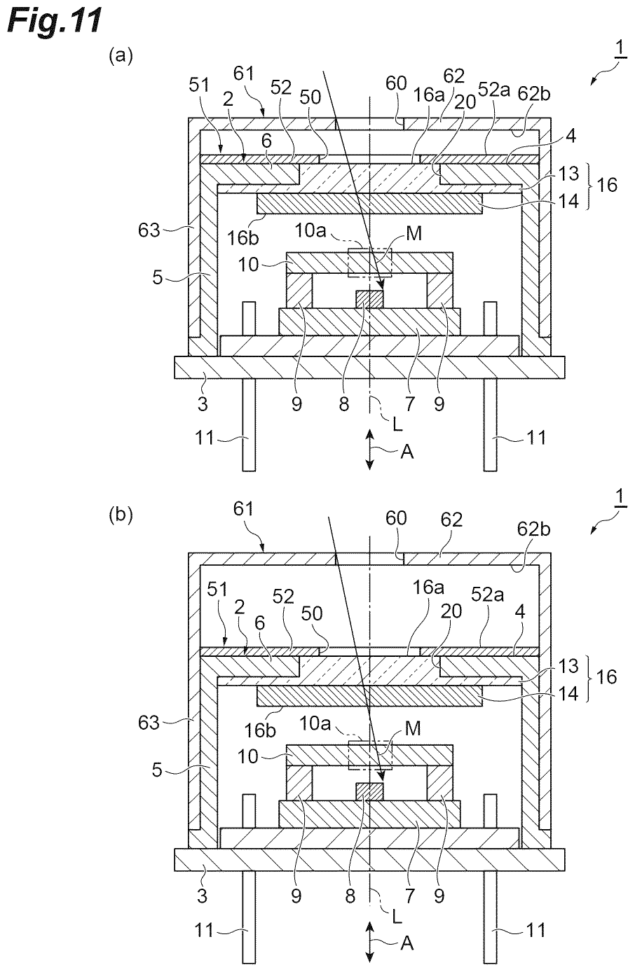

The distance between the first aperture 50 and the second aperture 60 in the light detecting device 1 illustrated in (a) of FIG. 11 is smaller than the distance between the first aperture 50 and the second aperture 60 in the light detecting device 1 illustrated in (b) of FIG. 11. In this case, in the light detecting device 1 as illustrated in (a) of FIG. 11, the incident angle of the light M that passes through the second aperture 60, the first aperture 50, and the opening 20, and enters the light transmission region 10a of the Fabry-Perot interference filter 10 becomes large. On the other hand, in the light detecting device 1 as illustrated in (b) of FIG. 11, the incident angle of the light M that passes through the second aperture 60, the first aperture 50, and the opening 20, and enters the light transmission region 10a of the Fabry-Perot interference filter 10 becomes small. Therefore, according to the light detecting device 1 in which the distance between the first aperture 50 and the second aperture 60 is large, the resolution can be improved in the wavelength analysis of the light to be measured as compared with the light detecting device 1 in which the distance between the first aperture 50 and the second aperture 60 is small. With the proviso that, even with the light detecting device 1 in which the distance between the first aperture 50 and the second aperture 60 is small, the resolution can be improved in the wavelength analysis of the light to be measured as compared with the light detecting device 1A not including the first aperture section 51 and the second aperture section 61.

In any of the light detecting devices 1 described above, when the stray light having entered the package 2 is reflected inside the package 2 and comes out to the outside through the opening 30 of the package 2 and the first aperture 50 of the first aperture section 51, the stray light is first absorbed by the surface 62b of the second aperture section 61 having light absorbency, subsequently absorbed by the surface 52a of the first aperture section 51 having light absorbency, and attenuated by being repeatedly reflected by the surfaces 52a and 62b. If the surface 62b of the second aperture section 61 does not have light absorbency, the possibility that stray light is reflected by the surface 62b and enters the package 2 again increases.

### Modifications

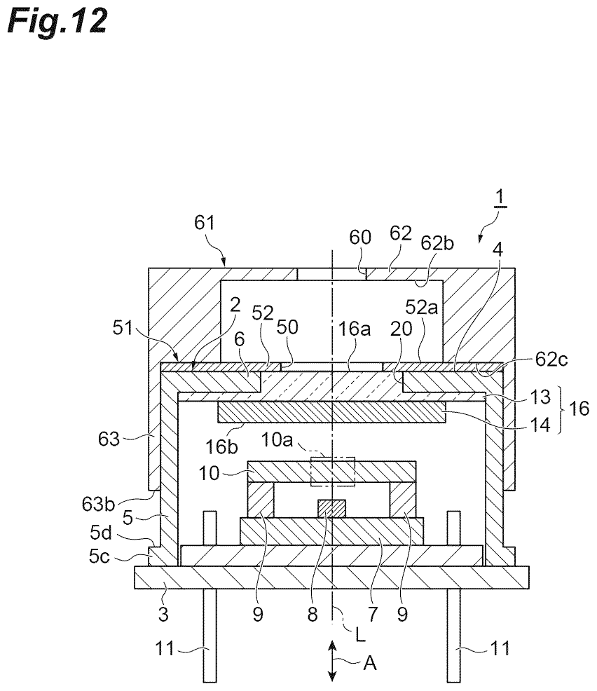

The present disclosure is not limited to the above embodiment. For example, the positioning of the second aperture section 61 in the direction A may be performed by the second surrounding part 62 of the second aperture section 61 and the first surrounding part 52 of the first aperture section 51. As a specific example thereof, in the light detecting device 1 illustrated in FIG. 12, the positioning of the second aperture section 61 in the direction A is performed by the contact between the surface 62c of the second surrounding part 62 and the surface 52a of the first surrounding part 52. The surface 62c is a surface of the second surrounding part 62 located on one side of the direction A with respect to the surface 62b and facing the one side of the direction A, and is a surface surrounding the surface 62b when viewed from the direction A. According to the light detecting device 1 illustrated in FIG. 12, at the time of manufacturing the light detecting device 1, each of the distance between the opening 20 and the second aperture 60 and the distance between the first aperture 50 and the second aperture 60 can be set to a predetermined distance by passive alignment.

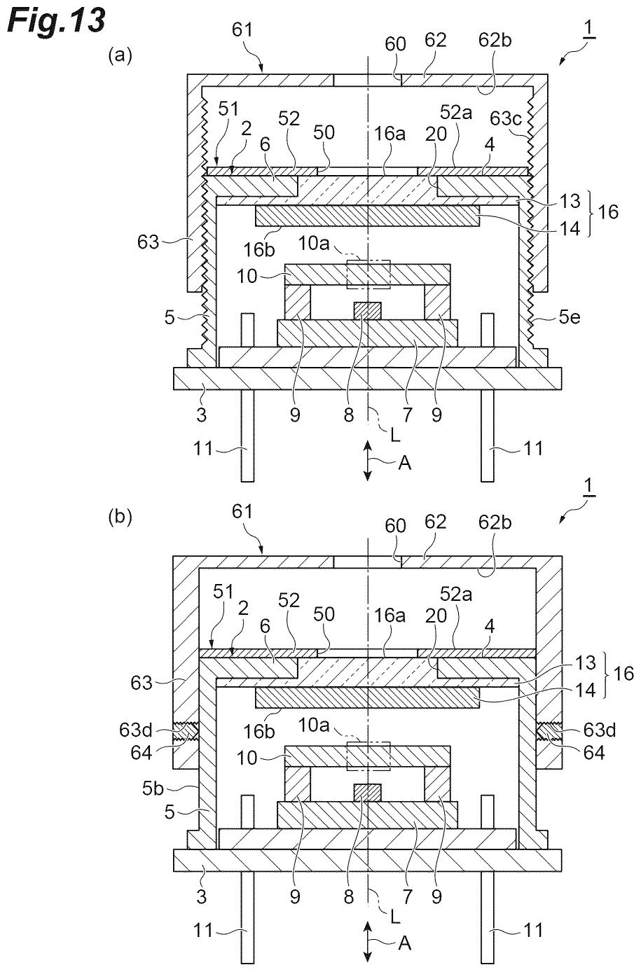

The second aperture section 61 may be attached to the package 2 so that the distance between the first aperture 50 and the second aperture 60 can be adjusted. As a specific example, in the light detecting device 1 illustrated in (a) of FIG. 13, a screw 5e is formed on the outer surface of the side wall 5 of the cap 4, and a screw 63c screwed with the screw 5e is formed on the inner surface of the fitting part 63 of the second aperture section 61. In the light detecting device 1 illustrated in (a) of FIG. 13, the distance between the first aperture 50 and the second aperture 60 is adjusted by rotating the second aperture section 61 with respect to the cap 4. In addition, in the light detecting device 1 illustrated in (b) of FIG. 13, at least one screw hole 63d is formed in the fitting part 63 of the second aperture section 61, and a set screw 64 pressed against the outer surface 5b of the side wall 5 of the cap 4 is screwed into the screw hole 63d. In the light detecting device 1 illustrated in (b) of FIG. 13, the set screw 64 is loosened, and the second aperture section 61 is moved in the direction A with respect to the cap 4, whereby the distance between the first aperture 50 and the second aperture 60 is adjusted. According to the light detecting device 1 illustrated in (a) and (b) of FIG. 13, by adjusting the distance between the first aperture 50 and the second aperture 60, it is possible to balance the light amount and the resolution in the wavelength analysis of the light to be measured.

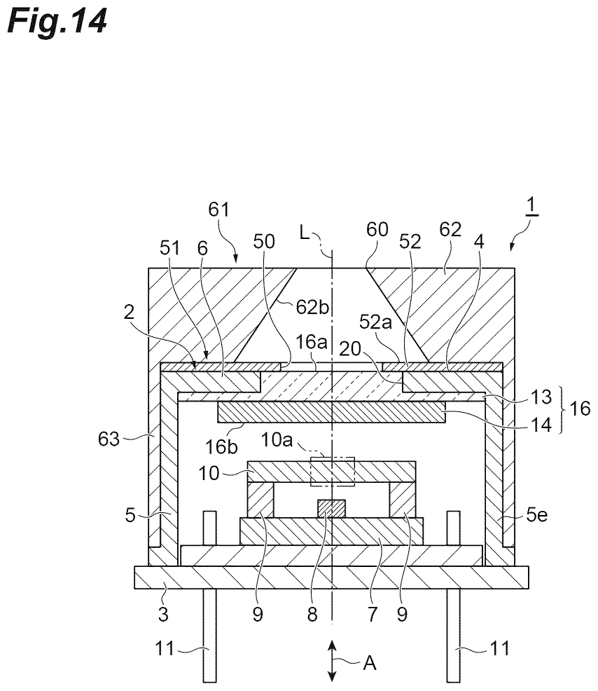

The surface 62b of the second aperture section 61 is not limited to a plane perpendicular to the direction A, and may be a plane surrounding the second aperture 60 when viewed from the direction A. As a specific example thereof, in the light detecting device 1 illustrated in FIG. 14, the surface 62b of the second aperture section 61 is an inclined surface that approaches the first aperture section 51 as it goes away outward from the outer edge of the second aperture 60. According to this configuration, since the strength of the second surrounding part 62 (a portion of the second aperture section 61 surrounding the second aperture 60) of the second aperture section 61 is increased, it is possible to suppress distortion generated in the second aperture section 61 at the time of machining and to obtain the second aperture section 61 with high accuracy. In addition, when the stray light entering the package 2 is reflected inside the package 2 and comes out to the outside through the opening 30 of the package 2 and the first aperture 50 of the first aperture section 51, even if a part of the stray light is not absorbed by the surface 62b which is the inclined surface, the stray light is easily reflected to the outside from the surface 62b which is the inclined surface, so that it is possible to suppress re-incidence of a part of the stray light into the package 2. In addition, the surface 52b of the first aperture section 51 is not limited to a plane perpendicular to the direction A, and may be a plane surrounding the second aperture 60 when viewed from the direction A. In addition, the surface 52a of the first aperture section 51 and the surface 62b of the second aperture section 61 may be separated from each other in a region overlapping each other when viewed from the direction A.

The first surrounding part 52 and the surface 52a may intermittently (for example, via a slit) surround the first aperture 50 when viewed from the direction A. When viewed from the direction A, the outer edge 50a of the first aperture 50 may match with the outer edge 20a of the opening 20 of the package 2, or may be located outside the outer edge 20a. When viewed from the direction A, the outer edge 50a of the first aperture 50 may match with the outer edge 60a of the second aperture 60, or may be located outside the outer edge 60a. The first aperture 50 may be closed by a light transmitting member. The first aperture 50 may be separated from the opening 20. In this case, the first aperture section 51 may include, for example, a support part that supports the first surrounding part 52 in a state of being disposed on the top wall 6 of the cap 4. The first aperture section 51 may not be attached to the package 2 but may be attached to another member.

The second surrounding part 62 and the surface 62b may intermittently (for example, via a slit) surround the second aperture 60 when viewed from the direction A. When viewed from the direction A, the outer edge 60a of the second aperture 60 may match with the outer edge 20a of the opening 20 of the package 2, or may be located outside the outer edge 20a. When viewed from the direction A, the outer edge 60a of the second aperture 60 may match with the outer edge 50a of the first aperture 50, or may be located inside the outer edge 50a. The second aperture 60 may be closed by a light transmitting member. The second aperture section 61 may not be attached to the package 2 but may be attached to another member.

In the above-described embodiment, the light transmission section 16 includes the light transmitting member 13, the bonding member 15, and the bandpass filter 14, but the light transmission section 16 may include only the light transmitting member 13. The light transmission section 16 may be a plate-like member disposed on an inner surface or an outer surface (specifically, the inner surface or the outer surface of the top wall 6) of the package 2. That is, the light transmission section 16 may close the opening 20 of the package 2.

A light absorbing film may be formed on at least a part (that is, the inner surface 5a of the side wall 5, the inner surface 6a of the top wall 6, the inner surface 3a of the stem 3, and the like) of the inner surface of the package 2. In this case, even if light having a large incident angle travels into the package 2 from the opening 20, the light can be attenuated by the light absorbing film formed on at least a part of the inner surface of the package 2, so that the stray light can be suppressed from entering the light detector 8.

### Configuration of Light Detection System

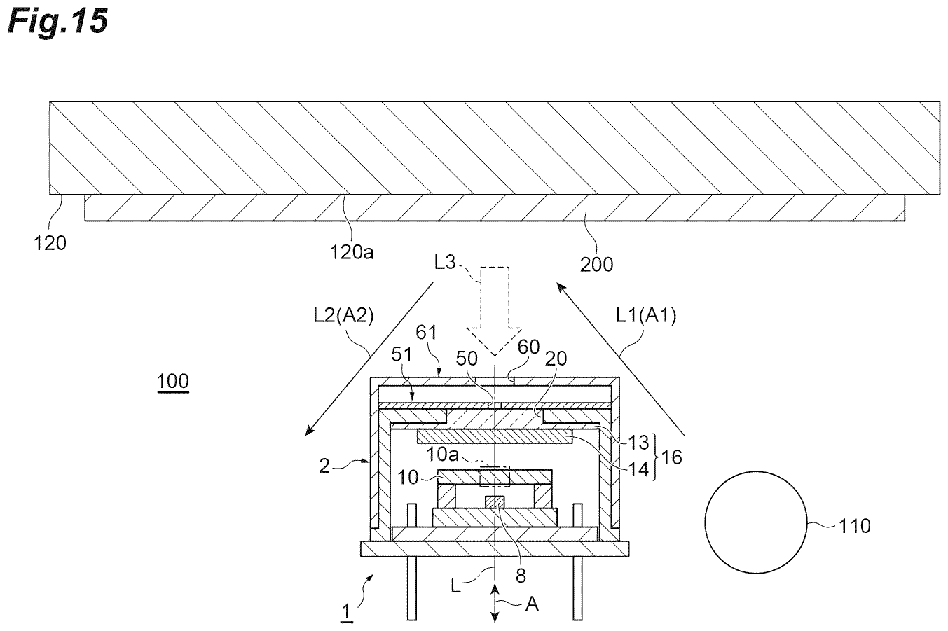

FIG. 15 is a configuration diagram of a light detection system 100 including the light detecting device 1. As illustrated in FIG. 15, the light detection system 100 includes the light detecting device 1, a light source 110, and a support 120. A sample 200 is disposed on a support surface 120a of the support 120. In the present embodiment, the support 120 is a white diffusion plate or a low reflection plate (a plate member made of a low reflection material). The light detecting device 1 and the light source 110 are arranged to face the support surface 120a. The light source 110 emits light L1 along an optical axis A1 having a predetermined incident angle with respect to the support surface 120a. The light source 110 is, for example, a light emitting diode that emits light in a near-infrared wavelength region. The light detecting device 1 is disposed at a position deviated from the optical axis A2 having an emission angle equal to the incident angle of the optical axis A1 in a case where the support surface 120a is a regular reflection surface. In the present embodiment, the light detecting device 1 is disposed between the optical axis A1 and the optical axis A2 in a state where the straight line L is perpendicular to the support surface 120a and the second aperture 60 faces the support surface 120a side.

In the light detection system 100 configured as described above, the regular reflection light L2 of the light L1 on the support surface 120a hardly enters the light detecting device 1, and diffuse reflection light L3 including the information of the sample 200 easily enters the light detecting device 1. Therefore, according to the light detection system 100, the S/N ratio and the resolution can be improved in the wavelength analysis of the diffuse reflection light L3 including the information of the sample 200.

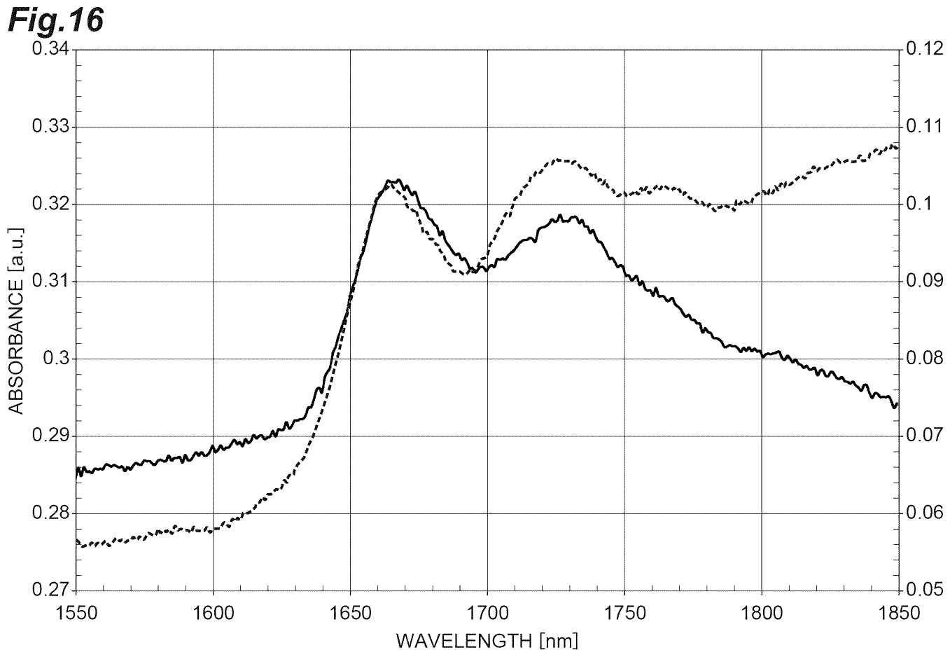

The light detection system of example and the light detection system of comparative example were prepared, and the polyester plate was subjected to spectroscopic analysis. The light detection system of the example has the same configuration as the light detection system 100 described above, and an aluminum foil is disposed between the support surface 120a and the sample 200 (that is, a polyester plate). The light detection system of the comparative example is different from the light detection system of the example only in that the light detecting device 1 is disposed on the optical axis A2. As a result, as illustrated in FIG. 16, in the result (solid line) of the spectroscopic analysis by the light detection system of the example, the absorbance decreased in the wavelength region of 1700 nm or more as compared with the result (broken line) of the spectroscopic analysis by the light detection system of the comparative example. From this, it can be said that according to the light detection system of the example, the S/N ratio and the resolution are improved in the wavelength analysis of light including information of the polyester plate as compared with the light detection system of the comparative example. In FIG. 16, the absorbance of the result (solid line) of the spectroscopic analysis by the light detection system of the example is indicated by the right vertical axis, and the absorbance of the result (broken line) of the spectroscopic analysis by the light detection system of the comparative example is indicated by the left vertical axis.

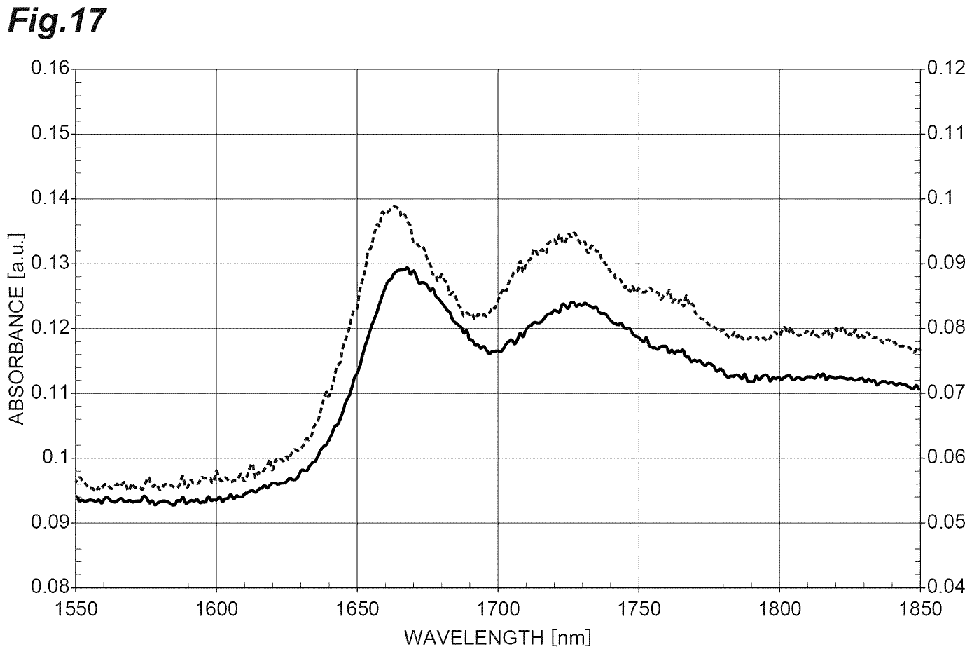

The light detection systems of Examples 1 and 2 were prepared, and the polyester plate was subjected to spectroscopic analysis. The light detection system of Example 1 has the same configuration as the light detection system 100 described above. The light detection system of Example 2 is different from the light detection system of Example 1 only in that the distance between the first aperture 50 and the second aperture 60 in the light detecting device 1 is larger than the distance in the light detection system of Example 1. As a result, as illustrated in FIG. 17, in the result (broken line) of the spectroscopic analysis by the light detection system of Example 2, undulations appearing in the absorbance were more remarkable than in the result (solid line) of the spectroscopic analysis by the light detection system of Example 1. From this, it can be said that according to the light detection system of Example 2, the resolution is improved in the wavelength analysis of light including information of the polyester plate as compared with the light detection system of Example 1. In FIG. 17, the absorbance of the result (solid line) of the spectroscopic analysis by the light detection system of the example 1 is indicated by the left vertical axis, and the absorbance of the result (broken line) of the spectroscopic analysis by the light detection system of Example 2 is indicated by the right vertical axis.

### REFERENCE SIGNS LIST

1 Light detecting device
2 Package
8 Light detector
10 Fabry-Perot interference filter
16 Light transmission section
20 Opening
20a Outer edge
35 First mirror section (mirror section)
36 Second mirror section (mirror section)
50 First aperture
50a Outer edge
51 First aperture section
52 First surrounding part
52a Side surface (first surface)
60 Second aperture
60a Outer edge
61 Second aperture section
62 Second surrounding part
62b Surface (second surface)
63 Fitting part
A Direction (first direction)

1. A light detecting device comprising:
a package having an opening;
a light transmission section closing the opening;
a Fabry-Perot interference filter disposed on one side of a first direction with respect to the opening and the light transmission section inside the package, and including a pair of mirror sections having a variable distance from each other in the first direction;
a light detector disposed on the one side of the first direction with respect to the Fabry-Perot interference filter inside the package;
a first aperture section having a first aperture located on the other side of the first direction with respect to the opening and the light transmission section outside the package; and
a second aperture section having a second aperture located on the other side of the first direction with respect to the first aperture outside the package,
wherein a first surface of the first aperture section facing the second aperture side and surrounding the first aperture has light absorbency, and
a second surface of the second aperture section facing the first aperture side and surrounding the second aperture is separated from the first surface, and has light absorbency.

2. The light detecting device according to claim 1, wherein an outer edge of the first aperture is located inside an outer edge of the opening when viewed from the first direction.

3. The light detecting device according to claim 1, wherein an outer edge of the second aperture is located inside an outer edge of the opening when viewed from the first direction.

4. The light detecting device according to claim 1,
wherein an outer edge of the first aperture is located inside an outer edge of the second aperture when viewed from the first direction, and
the outer edge of the second aperture is located inside an outer edge of the opening when viewed from the first direction.

5. The light detecting device according to claim 1,
wherein the first aperture section includes a first surrounding part surrounding the first aperture, and
positioning of the first aperture section in the first direction is performed by the first surrounding part and the package.

6. The light detecting device according to claim 5,
wherein the second aperture section includes a second surrounding part surrounding the second aperture, and a fitting part connected to the second surrounding part and fitted to the package,
positioning of the second aperture section in a second direction perpendicular to the first direction is performed by the fitting part and the package, and
positioning of the second aperture section in the first direction is performed by the fitting part and the package or by the second surrounding part and the first surrounding part.

7. The light detecting device according to claim 6, wherein positioning of the first aperture section in the second direction is performed by the first surrounding part and the fitting part.

8. light detecting device according to claim 1, wherein the second aperture section is attached to the package such that a distance between the first aperture and the second aperture is adjustable.

9. The light detecting device according to claim 1, wherein the second surface is an inclined surface approaching the first aperture section as the second surface is away outward from an outer edge of the second aperture.
